(19) United States
(12) Patent Application Publication
(10) Pub. No.: US 2007/0024822 A1
(43) Pub. Date: Feb. 1, 2007

(54) Switchable transparent display

(76) Inventors: Hubertus Maria Rene Cortenraad, Eindhoven (NL); Martin Gerard Hendrik Hiddink, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/578,063

(22) PCT Filed: Nov. 2, 2004
(86) PCT No.: PCT/IB04/52263

§ 371 Date: May 2, 2006

(30) Foreign Application Priority Data
Nov. 6, 2003 (EP) 03104095.9

(51) Int. Cl. G03B 21/14

(52) U.S. Cl. 353/79

(57) ABSTRACT

The present invention relates to a display device (100) arranged to operate in two different modes: a transparent mode and a display mode. The idea of the present invention is that a transparent plate (101) is provided with a plurality of light emitting means (102). The light emitting means are arranged in a grid which defines the pixels of the display device. The area of each light emitting means must be small compared to the area (104) of the corresponding pixel it illuminates, since the plate provided with the light emitting means must appear transparent to the human eye. A first switchable diffuser (103) is placed in front of the plate. Thus, the display device will appear virtually transparent when the diffuser is operated in the transparent mode, whereas when operated in the display mode, the light emitted from the light emitting means will be diffused and result in uniform pixels of the display device.

The present invention relates to a display device arranged to operate in two different modes: a transparent mode and a display mode.

With advances in display technology, mainly due to the fact that display devices are becoming cheaper, people tend to buy bigger and bigger display screens. This is a logical progression, since movies are enjoyed to a greater extent when viewed on a big screen, just consider the increasing number of home cinema systems sold in the last years. However, big display screens are rather bulky, and most users want them to take up as small space as possible when they are inactive, i.e. when they are not viewed. Either the display screen is stowed away and brought out when it is to be used, or sufficient free space is made available to keep the display screen out in the open permanently.

U.S. Pat. No. 5,416,617 discloses a display screen which is capable of being transparent outside operating mode, allowing light to pass through it, and becoming reflecting and diffusing like conventional display screens in operating mode. The display screen is a result from the combination of a cell comprising a polymer dispersed liquid crystal display which can be made diffusing, and of a cell comprising an electrochromic material which can be made absorbing and reflecting. Outside the operating mode, the display screen is transparent, and thus being capable of being fixed onto any surface, for example a window.

A problem with U.S. Pat. No. 5,416,617 is, however, that the display screen described is typically used as a display screen for image projection when it is associated with an image projection device comprising a light source provided with a CRT or a set of crystal matrices illuminated by a lamp. This has the effect that even though the display screen need not be stowed away when not in use, the screen still has to be associated with a projection device located at some distance from the screen. This provides a rather bulky display solution, since the display screen and the accompanying projection device are not integrated. Rather, they are two separate devices which need to be made cooperative with each other.

An object of the present invention is to provide a display device which solves the above-given problems and which offers an integrated display solution. It is further an object of the present invention to provide a display device which is essentially transparent in its non-operating mode such that the display device can be attached to, or integrated in, a window.

These objects are achieved by a display device arranged to operate in two different modes, a transparent mode and a display mode, in accordance with claim 1. Preferred embodiments are defined by the dependent claims.

According to an aspect of the invention, the display device comprises a transparent plate which is provided with a plurality of light emitting means, wherein each of the light emitting means is operative to illuminate a pixel area of the display device. The area of each light emitting means is smaller than its corresponding pixel area. The display device further comprises a first switchable diffuser consisting of, for example, a liquid crystal material. The diffuser is arranged to be transparent when the display device is operated in the transparent mode, and to diffuse the light emitted from at least part of the light emitting means when the display device is operated in the display mode. Said at least part of the light emitting means thereby illuminates the corresponding pixel area in the display mode.

The idea of the present invention is that a transparent plate, such as a glass plate in the form of a window or a glass plate hung up on a wall, is provided with a plurality of light emitting means. The light emitting means are arranged in a grid which defines the pixels of the display device. The area of each light emitting means must be small compared to the area of the corresponding pixel it illuminates. If the area of each light emitting means is sufficiently small compared to the corresponding pixel area, the transparent plate arranged with light emitting means will appear transparent to the human eye. A first switchable diffuser is placed in front of the plate. Thus, the display device will appear virtually transparent when the diffuser is operated in the transparent mode, whereas when operated in the display mode, the light emitted from the light emitting means will be diffused and result in uniformly illuminated pixels of the display device.

The present invention is advantageous, since it provides an integrated display solution comprising both display illumination means as well as the actual display screen. Moreover, because of the transparency property of the integrated display solution, it is possible to attach the display device to a window, or arrange the display device in the window. The display device can also be hung up on a wall or any other appropriate area where there is a desire to have a display device which is transparent when not operative. Due to the fact that the display device can be attached to a window or a wall, it will not occupy any effective space, and thus need not be stowed away when not operated. When the display device is not viewed, it will look transparent to the human eye, and thus be “invisible”.

C Display users tend to complain that the display device is not a nice sight when it is in its non-operating mode. The present invention will consequently eliminate this problem. In conference rooms having windows facing corridors or other rooms, the display device according to the invention can be used to convert said windows to opaque separations, placing the diffuser in the display mode but not activating the light emitting means. Another alternative is to activate the light emitting means and use the window as a display device showing desired images. A computer can be connected to the display device, wherein the display device can be used as an alternative to a projection unit showing, for example, overhead images. The present invention has yet further advantages in that it is possible to employ windows as advertising means, simply by attaching the display to the window and directing the display device towards the exterior side of the window.

According to an embodiment of the invention, the diffuser consists of a polymer dispersed liquid crystal (PDLC) material sandwiched between two sheets of conducting glass. When no electric field is applied to the conducting glass, the liquid crystals are randomly oriented, which creates the display mode. When an electric field is applied, the liquid crystals align parallel to the electric field and light passes through, creating the transparent mode.

According to another embodiment of the invention, the diffuser consists of a liquid crystal (LC) gel material. The LC gel functions in the opposite manner compared to the PDLC material. When no electric field is applied to the LC gel, the light passes through and thus the transparent mode is effected. When an electric field is applied, the display mode is activated.

The PDLC material has the advantage that it requires lower driving voltages than the LC gel material. The LC gel material on the other hand has the advantage that the display will be in its transparent mode when the power is off, which in some applications might be preferred. For the choice of PDLC material versus LC gel material, one has to take into account the actual application.

According to another embodiment of the invention, LED type light emitting means are used, such as regular LEDs, patches of OLED or PLED material etc.

According to yet another embodiment of the invention, an optical element is arranged at the respective light emitting means. The optical element has a focal length such that the respective light emitting means evenly illuminate the corresponding pixel area. This embodiment has the advantage that the uniformity of the light impinging on the pixel area can be improved. The optical element, e.g. a lens, should be placed in the proximity of the light emitting means and essentially have the same size as the emitting means.

According to a further embodiment of the invention, the light emitting means are arranged in lines and columns on the transparent plate, and addressing means are arranged to address the columns and lines of light emitting means. This has the advantage that each pixel of the display device can be addressed individually (and thus illuminated). The display device can either be passive or active, and in both cases the desired light emitting means are selected by activating the corresponding columns and rows. On the other hand if, for example, a company logo or some other “fixed” information is to be displayed, the addressing means are not necessary, since a fixed, predetermined pattern of light emitting means can then be arranged in accordance with another embodiment of the present invention.

According to yet a further embodiment of the present invention, a second switchable diffuser is arranged parallel to the first diffuser and on the opposite side of the transparent plate. The second diffuser is, like the first diffuser, arranged to be transparent when operated in a transparent mode and to diffuse the light emitted from at least part of the light emitting means when operated in a display mode. The light emitting means are operative to illuminate the corresponding pixel area in the display mode.

This embodiment has the advantage that the display device can be viewed from both sides. This also has the advantage that sunshine that may impinge on a display device which is attached to a window will, at least partly, be reflected at the second diffuser. Thus, the contrast of the opposite display side, i.e. the side on which the first diffuser is arranged, will be improved compared with the embodiment where only the first diffuser is employed. This embodiment further has the advantage that the second diffuser prevents the light emitting means from “leaking” directly in the direction of the window exterior. In case of light leakage in that direction, a viewer located on the exterior side of the window would look directly into the light without the second diffuser. Consequently, the viewer would experience this as unpleasant.

Further features of, and advantages with, the present invention will become apparent when studying the appended claims and the following description. Those skilled in the art realize that different features of the present invention can be combined to create embodiments other than those described in the following.

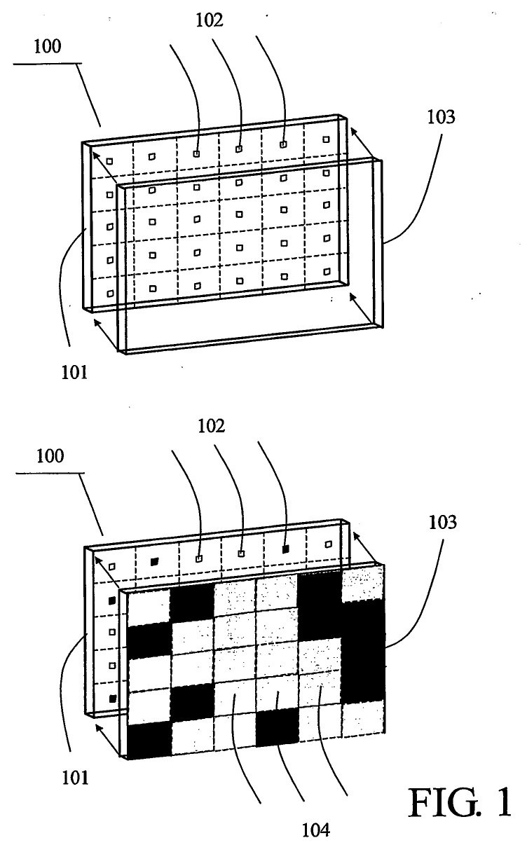

FIG. 1 shows a schematic view of a display device arranged to operate in a transparent mode and a display mode according to an embodiment of the invention;

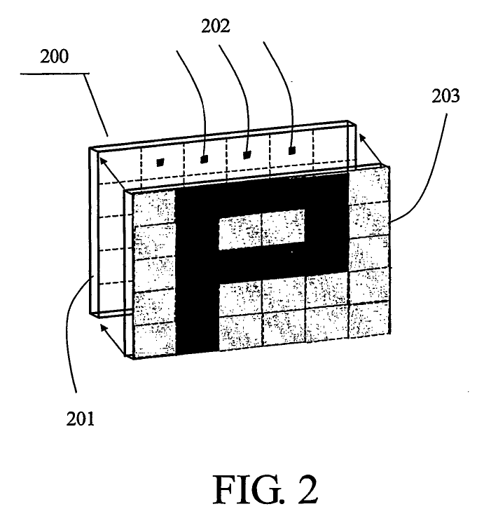

FIG. 2 illustrates a display device showing a logo or some other predetermined fixed pattern according to an embodiment of the invention;

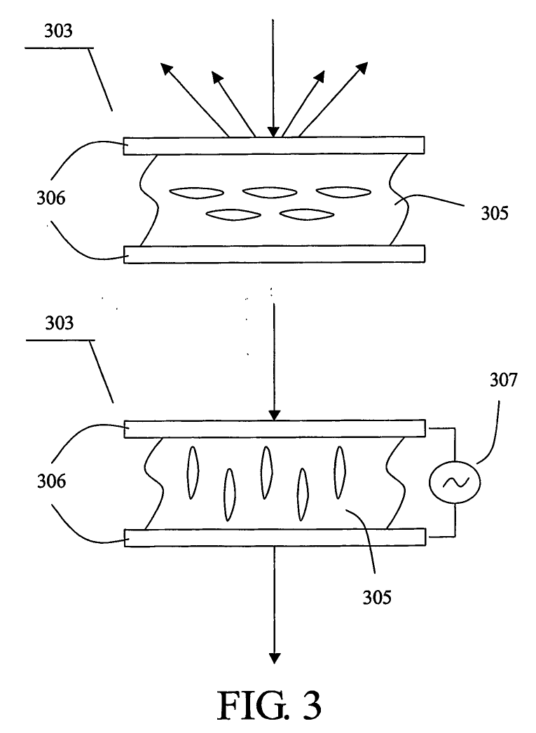

FIG. 3 shows a cross-sectional view of a diffuser consisting of liquid crystal material such as e.g. PDLC material according to embodiments of the invention;

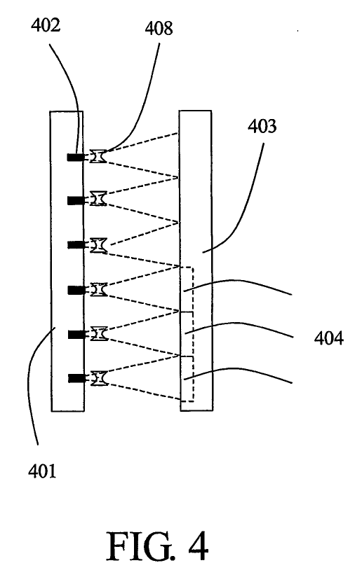

FIG. 4 shows the use of lenses in front of the transparent plate provided with light emitting means according to another embodiment of the invention; and

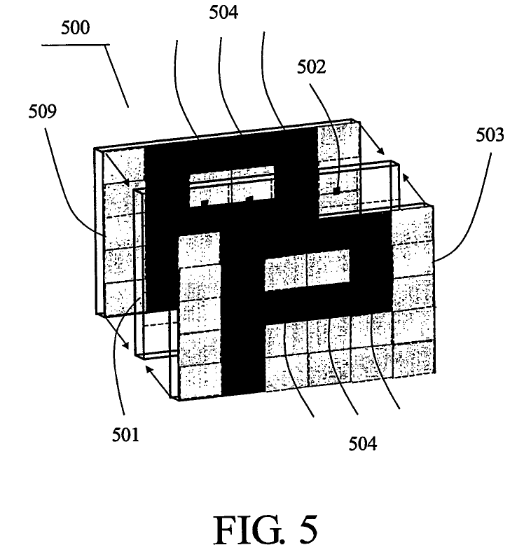

FIG. 5 shows a second switchable diffuser arranged parallel to the first diffuser and on the opposite side of the transparent plate according to yet another embodiment of the invention.

FIG. 1 shows a schematic view of a display device 100 arranged to operate in a transparent mode and a display mode according to an embodiment of the invention. A transparent plate 101 is provided with a plurality of light emitting means 102. In front of the transparent plate a switchable diffuser 103 is arranged. As will be described later, the diffuser consists of a liquid crystal material, which allows the diffuser and thereby the display device to be operated in a transparent mode and a display mode. The upper part of FIG. 1 shows the display device in its transparent mode, in which the display device appears virtually transparent. This is due to the fact that the area of each light emitting means, being for example LEDs, films of PLEDs or OLEDs, or some other appropriate light emitting means, are small compared to the area of each uniformly illuminated pixel 104 of the display, as can be seen in the lower part of FIG. 1. The lower part of FIG. 1 shows the display device when the diffuser is operated in its display mode. The darker pixels of the display illustrate that the corresponding light emitting means are activated, whereas the lighter pixels illustrate that the corresponding light emitting means are inactivated.

This way it is possible to provide an integrated display solution comprising both display illumination means as well as the actual display screen. The transparency feature of the display device makes it very easy and convenient to position it for example on a wall or on a window. Unlike many prior art display devices there is no need to stow it away when it is not used, since it does not occupy any effective space when attached to a wall or a window. This is an essential feature in modern homes, where compact living issues are often considered. The complexity of the addressing of the light emitting means depends on the application; if there is a desire to watch movies, which is often the case, the addressing must be fast.

However, as shown in FIG. 2, if it is only required to show a (company) logo or some other predetermined fixed pattern, in this case a “P”, no complex addressing is necessary, since it is not required to present moving pictures. Simply, the diffuser 203 is operated in the display mode and the light emitting means 202 are addressed to display a “P” on the display device 200. Alternatively, it is not necessary to provide a complete matrix of light emitting means, but merely the light emitting means necessary to create the desired image. In this case the addressing is very simple, and merely a case of turning the light emitting means on or off.

As previously mentioned, the diffuser can consist of liquid crystal material such as e.g. PDLC material or LC gel material. FIG. 3 shows a cross-sectional view of a PDLC diffuser 303, wherein the upper part shows the diffuser in its display mode, i.e. a light scattering mode, and the lower part of FIG. 3 shows the diffuser in its transparent mode. The liquid crystal material 305 is arranged between two transparent, conducting (glass) plates 306. As shown in the upper part of FIG. 3, when no electric field is applied between the glass plates 0306, the liquid crystals are randomly oriented which creates the display mode wherein light is scattered in many directions. When an electric field is applied, shown in the lower part of FIG. 3, by means of a voltage generator 307, the liquid crystals align parallel to the electric field and light passes through, creating the transparent mode. When LC gel is used, the liquid crystals are aligned when no electric field is applied, activating the transparent mode. When an electric field is applied, the liquid crystals scatter the light, and thus the display mode is activated.

FIG. 4 shows the use of lenses 408 in front of the plate 401 provided with light emitting means 402 according to an embodiment of the invention. Each lens has a focal length such that the respective light emitting means evenly illuminate the corresponding pixel area 404 on the diffuser 403. This has the advantage that the uniformity of the light impinging on the pixel area can be improved. It also has the advantage that, by choosing a proper lens, the light from the light emitting means is refracted such that a greater pixel area is created compared to the situation without the lens. The lens should be placed in the proximity of the light emitting means and essentially have the same size as the emitting means, so that the transparency property is not deteriorated.

The light emitting means shown in FIG. 1 and FIG. 2 can, as previously mentioned, be composed of PLED/OLED films. The PLED/OLED power can be supplied by transparent indium tin oxide (ITO) electrodes, as is known in the prior art.

FIG. 5 shows another embodiment of the invention, wherein, additionally to what is illustrated in FIG. 1 and FIG. 2, a second switchable diffuser 509 is arranged parallel to the first diffuser 503 and on the opposite side of the transparent plate 501. The second diffuser is, like the first diffuser, arranged to be transparent when operated in a transparent mode and to diffuse the light emitted from at least part of the light emitting means 502 when operated in a display mode. The light emitting means are operative to illuminate the corresponding pixel area 504 in the display mode. The second diffuser may or may not be identical with the first diffuser.

This embodiment is advantageous, since the display device can be viewed from both sides. It is also advantageous since the sunshine that may impinge on a display device which is attached to a window will, at least partly, be reflected against the second diffuser 509. Thus, the contrast of the opposite display side, i.e. the side on which the first diffuser 503 is arranged, will be improved compared with the embodiment where only one diffuser is employed.

Note that if the light emitting means do not “leak” light directly in the direction of the window exterior, one can also look at the first diffuser from the exterior side of the window since part of the light is scattered from the first diffuser in the exterior direction. If, for example, a metal cathode is used for the PLED or OLED material, no light leaks in the direction of the window exterior.

Even though the invention has been described with reference to specific exemplifying embodiments thereof, many different alterations, modifications and the like will become apparent to those skilled in the art. The embodiments described are therefore not intended to limit the scope of the invention, as defined by the appended claims.

1. A display device (100) arranged to operate in two different modes: a transparent mode and a display mode, the display device being characterized in that it comprises
a transparent plate (101) provided with a plurality of light emitting means (102), wherein each of said light emitting means is operative to illuminate a pixel area (104) of the display device, the area of each light emitting means being smaller than its corresponding pixel area; and
a first switchable diffuser (103) arranged to be transparent when operated in said transparent mode and to diffuse the light emitted from at least part of the light emitting means (102) when operated in said display mode, wherein said at least part of the light emitting means is operative to illuminate the corresponding pixel area in said display mode.

2. The display device according to claim 1, wherein said light emitting means (102) are LEDs.

3. The display device according to claim 1, wherein said light emitting means (102) are made of PLED or OLED material.

4. The display device according to claim 1, wherein the diffuser (503, 509) consists of a polymer dispersed liquid crystal (PDLC) material (305) arranged between two sheets of conducting glass (306), which diffuser operates in the transparent mode when an electric field is applied to the conducting glass and in the display mode when no electric field is applied to the conducting glass.

5. The display device according to claim 1, wherein the diffuser (503, 509) consists of a liquid crystal (LC) gel (305) material arranged between two sheets of conducting glass (306), which diffuser operates in the display mode when an electric field is applied to the conducting glass and in the transparent mode when no electric field is applied to the conducting glass.

6. The display device according to claim 1, further comprising:
an optical element (408) arranged at the respective light emitting means (402), the optical element having a focal length such that said respective light emitting means evenly illuminates the corresponding pixel area (404).

7. The display device according to claim 1, wherein the light emitting means (102) are arranged in rows and columns on the transparent plate (101), the display further comprising:
addressing means arranged to address the rows and columns of the light emitting means.

8. The display device according to claim 1, wherein the light emitting means (202) provided in the plate (201) are interconnected such that a fixed predetermined image can be shown on the display when the diffuser (203) is operated in the display mode.

9. The display device according to claim 1, further comprising a second switchable diffuser (509) arranged parallel to the first diffuser (503) and on the opposite side of the transparent plate (501), which second diffuser is arranged to be transparent when operated in a transparent mode and to diffuse the light emitted from at least part of the light emitting means (502) when operated in a display mode, wherein said at least part of the light emitting means is operative to illuminate the corresponding pixel area (504) in the display mode.
